(19) United States
(12) Patent Application Publication
(10) Pub. No.: US 2025/0350604 A1
(43) Pub. Date: Nov. 13, 2025

(54) REMOTE ACCESS BROKER FOR SECURE EQUIPMENT ACCESS

(71) Applicant: Cisco Technology, Inc., San Jose, CA (US)

(72) Inventors: Ryan HOLLAND, Pacifica, CA (US); Aaron SELESI, Simi Valley, CA (US); Sravanth YAJAMANAM, San Jose, CA (US); Michael FREED, Pleasanton, CA (US); Elango GANESAN, Palo Alto, CA (US)

(21) Appl. No.: 18/661,838

(22) Filed: May 13, 2024

(51) Int. Cl. H04L 9/40

(52) U.S. Cl. CPC H04L 63/102

(57) ABSTRACT

In one embodiment, a method includes determining, by an access broker, a first group of users of a first tenant within a computer network and exposing, by the access broker, the first group of users to a second tenant within the computer network. The method may further include receiving, by the access broker, a selection of particular users from the first group of users for which the second tenant has granted remote access to one or more networked assets of the second tenant and managing, by the access broker, access of the particular users of the first tenant to the one or more networked assets of second tenant based on a group configuration for the first group of users by the first tenant and the selection of the particular users by the second tenant.

### TECHNICAL FIELD

The present disclosure relates generally to computer networks, and, more particularly, to a remote broker for secure equipment access.

### BACKGROUND

It is increasingly common for different organizations (e.g., companies, etc.) to form partnerships with one another to accomplish various goals. Frequently such partnerships can necessitate access management and permissions across the organizations. For example, a utility company (or multiple utility companies) may form a partnership with a power grid battery company (or multiple power grid battery companies), where battery technicians may need to access their batteries on the utility company's networking for troubleshooting or other purposes. Managing user access across these different organizations, however, has been a cumbersome task, either requiring too much manual intervention and configuration, or too little control and security.

### BRIEF DESCRIPTION OF THE DRA WINGS

The embodiments herein may be better understood by referring to the following description in conjunction with the accompanying drawings in which like reference numerals indicate identically or functionally similar elements, of which:

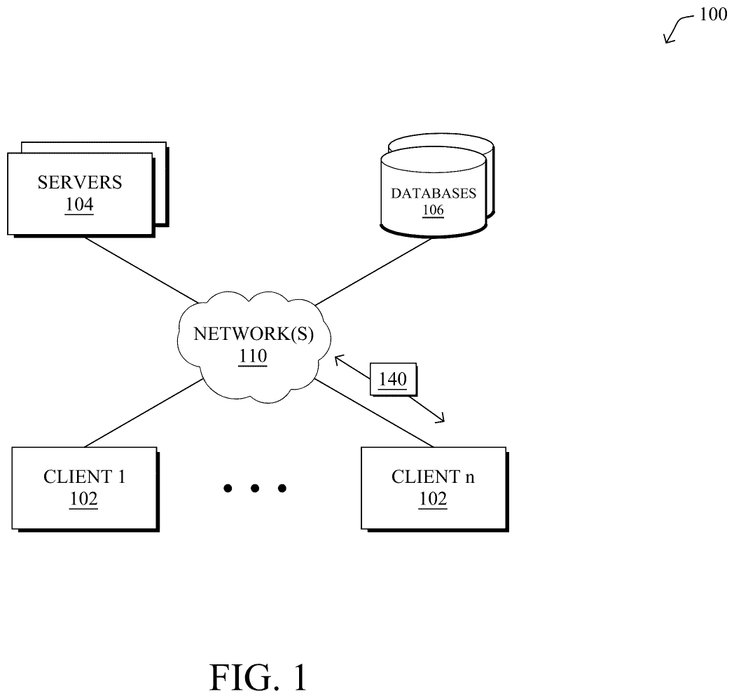

FIG. 1 illustrates an example computing system;

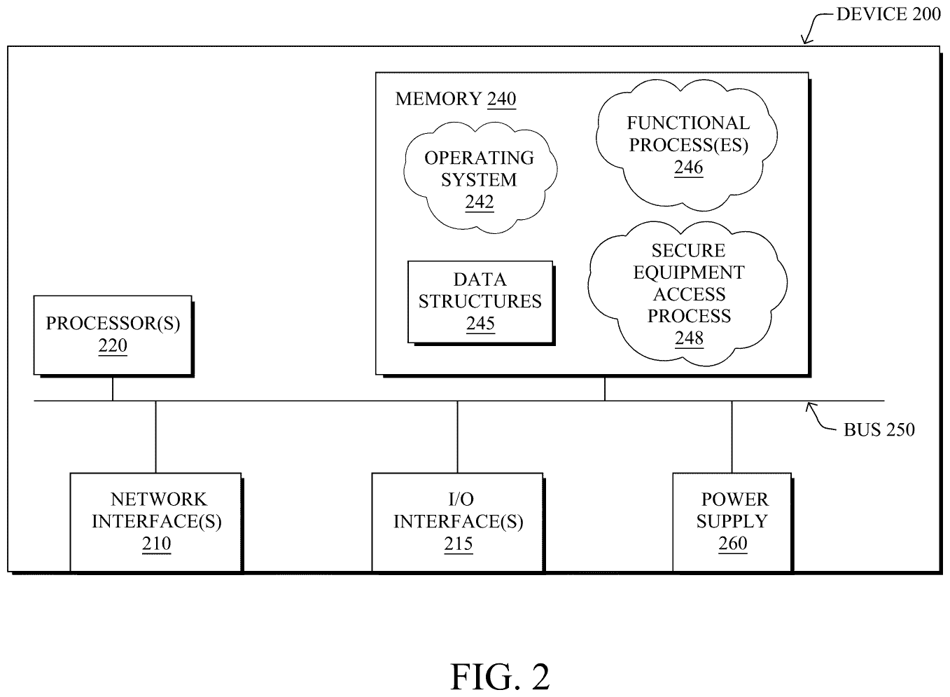

FIG. 2 illustrates an example network device/node;

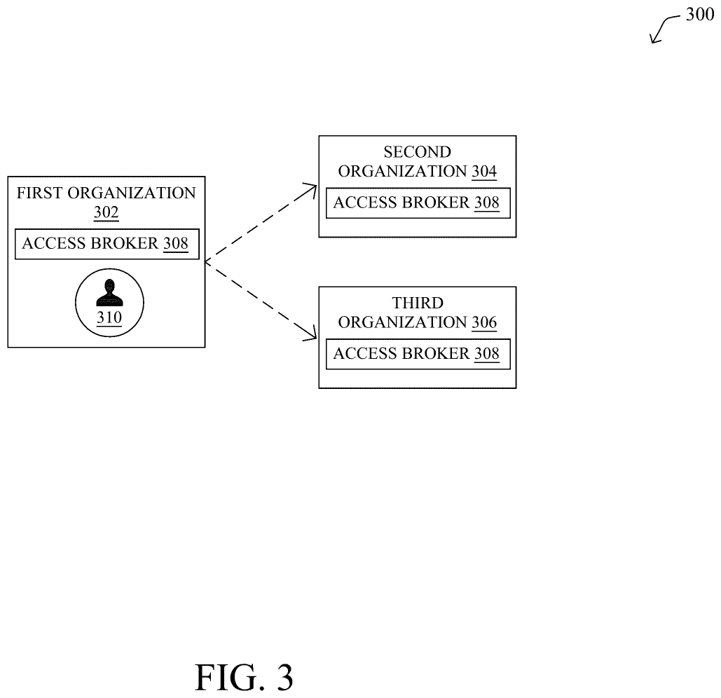

FIG. 3 illustrates and example system for a remote broker for secure equipment access in accordance with one or more embodiments described herein;

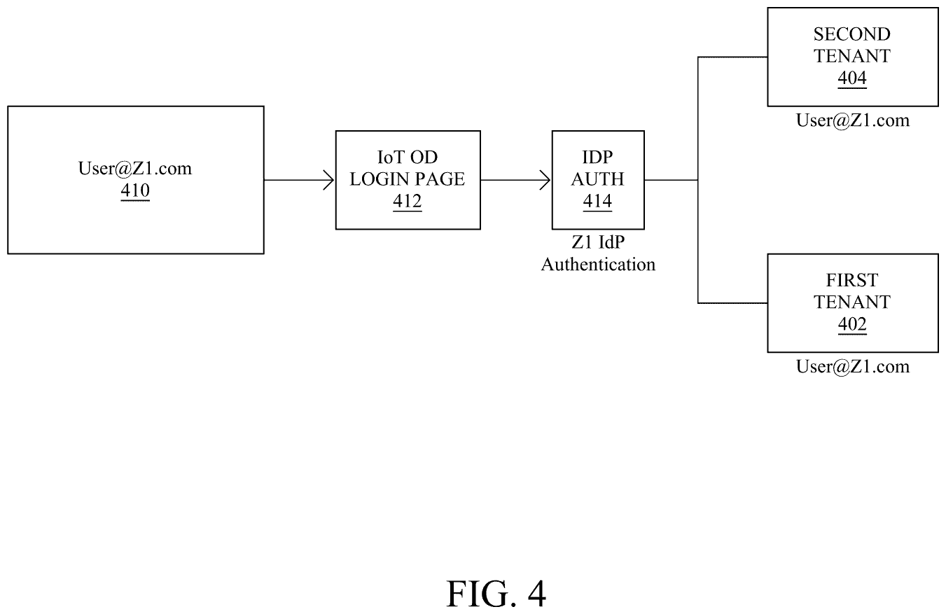

FIG. 4 illustrates an example of adding a user to multiple tenants in accordance with one or more embodiments described herein;

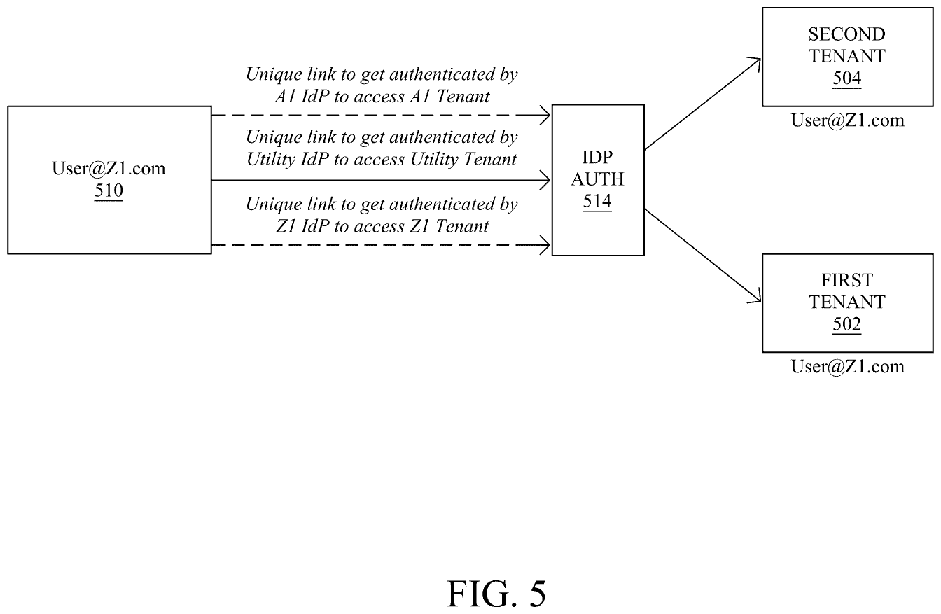

FIG. 5 illustrates an example of adding a user to multiple tenants in accordance with one or more embodiments described herein;

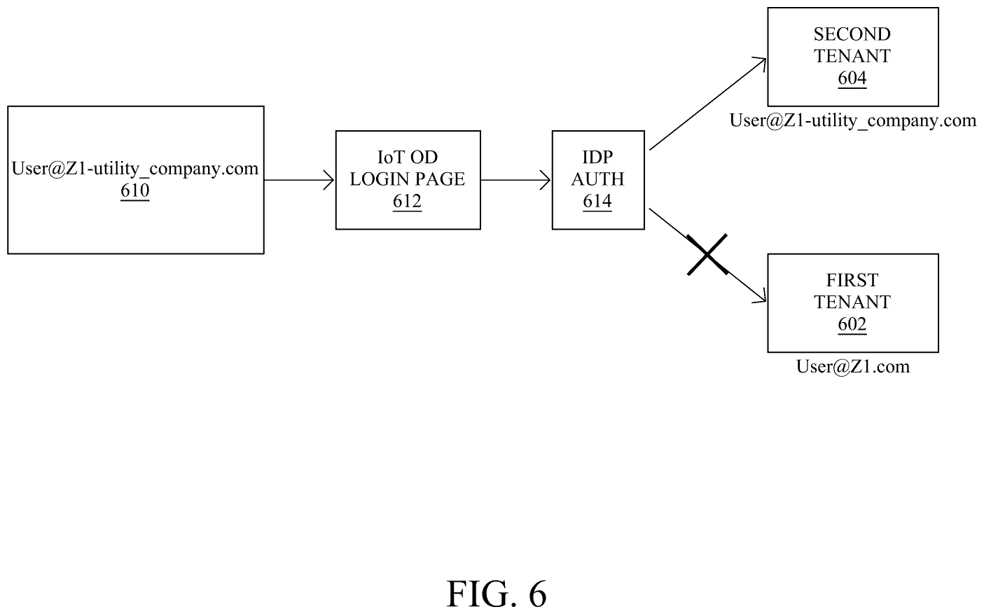

FIG. 6 illustrates yet another example of adding a user to multiple tenants in accordance with one or more embodiments described herein; and

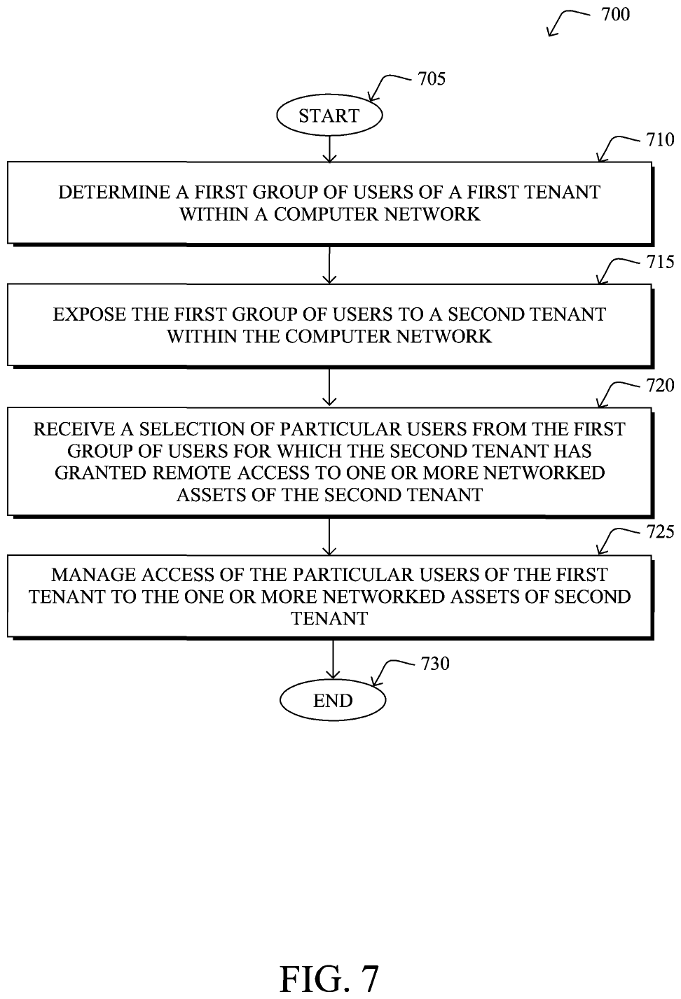

FIG. 7 illustrates an example procedure for remote broker for secure equipment access in accordance with one or more embodiments described herein.

### DESCRIPTION OF EXAMPLE EMBODIMENTS

### Overview

According to one or more embodiments of the disclosure, a method includes determining, by an access broker, a first group of users of a first tenant within a computer network and exposing, by the access broker, the first group of users to a second tenant within the computer network. The method may further include receiving, by the access broker, a selection of particular users from the first group of users for which the second tenant has granted remote access to one or more networked assets of the second tenant and managing, by the access broker, access of the particular users of the first tenant to the one or more networked assets of second tenant based on a group configuration for the first group of users by the first tenant and the selection of the particular users by the second tenant.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a secure equipment access process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Remote Broker for Secure Equipment Access

As noted above, there are often significant issues regarding access management and permissions across multiple organizations. For instance, assume that a first utility company and a second utility company are customers of an energy company (e.g., a power grid battery company or other energy company). In this example, all three of the organizations may have their own respective Internet-of-Things (IoT) operations dashboard (OD) for accounts and tenants. It can further be assumed that each of the organizations have their own respective identity providers (IDPs) with OD (e.g., via Connected Communities Infrastructure (CCI)).

As an example, “John Smith” (john@energy_comany.com) is a technician at the energy company and his email address is an entry present on the IDP of the energy company. In this example, John may require remote access to batteries manufactured by the energy company that are in us at the first utility company and the second utility company. In addition, John may also be provided remote access to batteries at the energy company where he works as well. Now we assume that John leaves the energy company. It follows that after leaving the company, John should no longer have access to the batteries at the first utility company, the second utility company, or the energy company.

Traditionally this can be handled in two different ways. A first solution would be to allow the energy company (and other vendors) to create IoT OD accounts and integrate them with their corresponding IDPs. There is no need for additional networking hardware (e.g., routers and switches), and in general these are zero cost accounts. Also, customers such as the first utility company and/or the second utility company can simply add technicians at the energy company by email ID. For example, the first utility company and/or the second utility company can add john@energy_comany.com to a tenant with a remote access user role and then add john@energy_comany.com to an appropriate secure equipment access role.

A second solution would be to have the first utility company and/or the second utility company create a new tenant, e.g., called “External,” which points to its own IDP (domain: utility_company-external.com). As such, John at the energy company has his own account: john-energy@ utility_company-external.com. Now the first utility company and/or the second utility company will have to manage on-boarding and off-boarding users from the energy company. Also, the first utility company and/or the second utility company can give access to users from the energy company using existing OD features. One caveat here, however, is that John now has another e-mail account to deal with, and the first utility company and/or the second utility company needs to manage this e-mail account.

However, none of these solutions utilize a Remote Access Broker that allows for sharing lists or groups of users, where a “double approval” process allows both tenants to be involved in the approval of access for the users or groups for remote access sessions, without any onboarding, shared accounts, new email registrations, or other generally known solutions.

The techniques herein (e.g., a Multi-Party Industrial Remote Access Broker techniques) therefore allow for a Cross-Tenant Vendor IDP that shares info between tenants via a remote access broker (e.g., secure equipment access), such as lists or groups of users, where a “double approval” process allows both tenants to be involved in the approval of access for the users or groups for remote access sessions.

Specifically, according to one or more embodiments of the disclosure as described in detail below, a method includes determining, by an access broker, a first group of users of a first tenant within a computer network and exposing, by the access broker, the first group of users to a second tenant within the computer network. The method may further include receiving, by the access broker, a selection of particular users from the first group of users for which the second tenant has granted remote access to one or more networked assets of the second tenant and managing, by the access broker, access of the particular users of the first tenant to the one or more networked assets of second tenant based on a group configuration for the first group of users by the first tenant and the selection of the particular users by the second tenant.

Operationally, FIG. 3 illustrates a system 300 for a remote broker for secure equipment access in accordance with one or more embodiments described herein. As shown in FIG. 3, the system 300 includes a plurality of organizations (or other controlling entities, enterprises, companies, institutions, domains, etc.), e.g., first organization 302, second organization 304, third organization 306, etc. Each of the organization may have access to an access broker 308. For example, the techniques herein provide improvements to the existing solutions by positioning an operations dashboard (OD) as a Multi-Party Industrial Remote Access Broker (e.g., access broker 308).

For example, when multiple parties (e.g., first organization 302, second organization 304, and third organization 306, etc.) each share the same registration with the OD (e.g., Secure Equipment Access (SEA) by Cisco®, or other suitable OD), the techniques herein allow one party to easily add technicians (e.g., the technician 310) from third-party vendors to their tenants. This can allow a network effect among vendors and customers when sharing the access broker 308.

In a non-limiting illustrative example, assume that there are two tenants (e.g., the first organization 302 and the second organization 304 or the first organization 302 and the third organization 306, etc.), which must keep separate, but that also must allow adding a user (e.g., the technician 310) to multiple tenants. Continuing with the example above, an admin of the first organization 302 may define one or more technicians for batteries, and the admin of the second organization 304 may request a need for someone (e.g., the technician 310) from the first organization 302 to look at a particular battery to, for example, troubleshoot issues with said battery.

In some implementations, Cross-Tenant Vendor IDP may be based on a number of specific solutions each essentially encompassing sharing info between tenants via a remote access broker (e.g., access broker 308, which may be a SEA access broker or other suitable such access broker). This information that may be shared between the tenants can include lists or groups of users and may utilize a “double approval” paradigm where both tenants are involved in the approval of access for users, such as the technician 310, that are given access to the system 300 or portions thereof.

Continuing with the non-limiting example given above where a first utility company (e.g., the second organization 304) and a second utility company (e.g., the third organization 306) are customers of an energy company (e.g., the first organization 302) and all three of the organizations may have their own respective IoT OD for accounts and tenants, as well their own respective identity providers IDPs with OD (e.g., via Connected Communities Infrastructure (CCI)), an admin at one of the organizations (e.g., the first organization 302) may see that an admin of the second organization 304 and/or an admin of the third organization 306 may need remote access from the admin of the first organization 302 regarding a battery (or other remotely accessible asset, including, but not limited to computing devices, network devices, wearables, hardware devices, IoT devices, etc.).

The admin of the first organization 302 may select a group of “peers” to grant access to one or more users. The second organization 304 and/or the third organization 306 may then accept the access exposing a number of users such that the second organization 304 and/or the third organization 306 can allow access to those users, accordingly. The access groups or group of “peers” may include various subsets of users, such as a geographical group (e.g., “North America Battery Group,” etc.) and/or a certain quantity of users associated with such groups (e.g., twenty within the North America Battery Group), although it will be appreciated that implementations are not limited to the exemplary examples.

Stated alternatively, the first organization 302 may approve certain users or subsets of users to access the second organization 304 and/or the third organization 306 and the second organization 304 and/or the third organization 306 can, in turn approve certain users or subsets of users to access first organization 302. Accordingly, in accordance with the disclosure, each tenant may authenticate their own users, but the cross-correlation between tenants defines the authorization of what those users can then do and/or access across the other participating tenants.

In one implementation, users may be specifically listed within particular groups and/or roles, and these users may be shared between tenants as follows. The first organization 302 (e.g., an admin of the first organization 302) creates a list of users (e.g., the technician 310) and exposes this list of users to a tenant associated with a different organization (e.g., the second organization 304 and/or the third organization 306). The second organization 304 and/or the third organization 306 (e.g., an admin of the second organization 304 and/or the third organization 306) can then add users from the list of users exposed by the first organization 302 to the tenant associated with their own organization. In some implementations this process can include adding various roles (e.g., remote access roles, etc.) and/or assigning various groups (e.g., secure equipment access groups, etc.).

Continuing with this example, the second organization 304 and/or the third organization 306 can remove access to one or more users associated with the first organization 302. The first organization 302 can remove access to one or more of its' own users. In response to removal of access to the user(s) by the first organization 302, these user(s) can be automatically removed from access to the second organization 304 and/or the third organization 306.

In some implementations, the users within the groups may be hidden, thereby only exposing only the users that are specifically listed within particular groups and/or roles. In such implementations, any user within that group and/or role may be granted access. For example, the first organization 302 may create one or more groups of users and exposes just the groups to the second organization 304 and/or the third organization 306. In these implementations, the second organization 304 and/or the third organization 306 may trust the first organization 302 and may add various roles (e.g., remote access roles, etc.) and/or assigning various groups (e.g., secure equipment access groups, etc.) to these trusted groups of users.

It is noted that, in some implementations, the IDP security policy (e.g., password strength, rotation, device posture, etc.) of one or more of the organizations may be exposed to one or more of the participating organizations. This feature may allow for the various organizations to make informed decisions on how trustworthy such policies are from other participating organizations. In addition to, or in the alternative, these features may allow for the various organizations to enforce their own security policies (e.g., multi-factor authentication, etc.) on the users within the groups and/or may have the opportunity to deny access to specific groups and/or users.

FIG. 4 illustrates an example of adding a user to multiple tenants in accordance with one or more embodiments described herein. In the example of FIG. 4, a user 410 having an address of user@z1.com, should be able to access both the first tenant 402 (e.g., the first organization 302 of FIG. 3) in addition to the second tenant 404 (e.g., the second organization 304 of FIG. 3). In some embodiments, the user 410 can be the technician 310 of FIG. 3, although implementations are not so limited.

In this example, the user 410 can be added to both the first tenant 402 and the second tenant 404 by a respective admin of the first tenant 402 and the second tenant 404. In some implementations, the user 410 can be added to these tenants with a specific role, set of permissions, particular level of access, etc. Subsequent to the user being added to the first tenant 402 and the second tenant 404, the user 410 can login using an IoT OD Login Page 412. The user 410 is then authenticated using the IoT OD Login Page 412 and/or IDP authenticator 414, provided that IDP authentication is configured. Upon successful authentication, the user 410 will then be granted access to the first tenant 402 and the second tenant 404.

FIG. 5 illustrates an example of adding a user to multiple tenants in accordance with one or more embodiments described herein. In the example of FIG. 5, a user 510 having an address of user@z1.com, should be able to access both the first tenant 502 (e.g., the first organization 302 of FIG. 3) in addition to the second tenant 504 (e.g., the second organization 304 of FIG. 3) using a same username. In some embodiments, the user 510 can be the technician 310 of FIG. 3, although implementations are not so limited.

In this example, the user 510 can be added to both the first tenant 502 and the second tenant 504 by a respective admin of the first tenant 502 and the second tenant 504. In some implementations, the user 510 can be added to these tenants with a specific role, set of permissions, particular level of access, etc. Subsequent to the user being added to the first tenant 502 and the second tenant 504, the user 510 will use a unique link to get authenticated by a the IDP authenticator 514.

FIG. 6 illustrates yet another example of adding a user to multiple tenants in accordance with one or more embodiments described herein. In the example of FIG. 6, a user 610 having an address of user@z1-utility_company.com, should be able to access both the first tenant 602 (e.g., the first organization 302 of FIG. 3) in addition to the second tenant 604 (e.g., the second organization 304 of FIG. 3) using a same username. In some embodiments, the user 610 can be the technician 310 of FIG. 3, although implementations are not so limited.

In this example, z1-utility_company.com may be added to the IDP domain list for the second tenant 604, while the email address user@z1-utility_company.com is mapped to the working email address of the user 610. Next, the email address user@z1-utility_company.com is added to the second tenant 604 by an admin associated with the second tenant 604. In some implementations, the user 610 can be added to these tenants with a specific role, set of permissions, particular level of access, etc.

The user 610 is then authenticated using the IoT OD Login Page 612 and/or IDP authenticator 614, provided that IDP authentication is configured. Upon successful authentication, the user 610 will then be granted access to the first tenant 602 and the second tenant 604.

In closing, FIG. 7 illustrates an example procedure for remote broker for secure equipment access in accordance with one or more embodiments described herein. In some implementations, a non-generic, specifically configured device (e.g., device 200, an apparatus) may perform procedure 700 by executing stored instructions (e.g., process 248). The procedure 700 may start at step 705, and continues to step 710, where, as described in greater detail above, an access broker determines a first group of users of a first tenant within a computer network.

The procedure 700 may continue to step 715 where, as described in greater detail above, the access broker exposes the first group of users to a second tenant within the computer network. In some implementations, the first group of users can be identified as individual users. Implementations are not so limited, however, and in some implementations, the first group of users can be identified by a group name and individual users within the first group of users may be obfuscated. In yet other implementations, the access broker may expose just one of the first group of users, individual users, or the particular users.

The procedure 700 may continue to step 720 where, as described in greater detail above, the access broker receives a selection of particular users from the first group for which the second tenant has granted remote access to one or more networked assets of the second tenant. In some implementations, the selection of the particular users can be selected from a group consisting of: an entirety of the first group; one or more subgroups of the first group; and a subset of individual users from the first group.

The procedure 700 may continue to step 725 where, as described in greater detail above, the access broker manages access of the particular users of the first tenant to the one or more networked assets of second tenant based on a group configuration for the first group by the first tenant and the selection of the particular users by the second tenant. In some implementations, the procedure 700 can include receiving secure equipment access permissions for the particular users based on managing access of the particular users of the first tenant to the one or more networked assets of second tenant.

The procedure 700 can further include receiving access revocation of one or more of the particular users by the second tenant and revoking access of the one or more of the particular users from the one or more networked assets of second tenant in response to the access revocation. In such implementations, access revocation of the one or more of the particular users can comprise removing an individual user from the one or more of the particular users or removing a subset of users from the one or more of the particular users.

In some implementations, the procedure 700 can include receiving an update to the first group from the first tenant and updating the access according to the update. The update can, among other things, include adding users and, if all users of the second tenant group are selected, adding access to new users in the second tenant group; adding users, and if individual users of second tenant group are selected, exposing new users but only allowing access if the second tenant grants access to added users; or removing users and auto-removing access to such users from second tenant.

Procedure 700 may end at step 730.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: determining, by an access broker, a first group of users of a first tenant within a computer network; exposing, by the access broker, the first group of users to a second tenant within the computer network; receiving, by the access broker, a selection of particular users from the first group for which the second tenant has granted remote access to one or more networked assets of the second tenant; and managing, by the access broker, access of the particular users of the first tenant to the one or more networked assets of second tenant based on a group configuration for the first group by the first tenant and the selection of the particular users by the second tenant. In still other implementations, a tangible, non-transitory, computer-readable medium storing program instructions that cause a device to execute a process comprising: determining, by an access broker, a first group of users of a first tenant within a computer network; exposing, by the access broker, the first group of users to a second tenant within the computer network; receiving, by the access broker, a selection of particular users from the first group for which the second tenant has granted remote access to one or more networked assets of the second tenant; and managing, by the access broker, access of the particular users of the first tenant to the one or more networked assets of second tenant based on a group configuration for the first group by the first tenant and the selection of the particular users by the second tenant regardless of whether a group or an individual was granting said access.

The techniques described herein, therefore, provide for a remote broker for secure equipment access. As discussed above, the techniques herein (e.g., a Multi-Party Industrial Remote Access Broker techniques) allow for a Cross-Tenant Vendor IDP that shares info between tenants via a remote access broker (e.g., secure equipment access), such as lists or groups of users, where a “double approval” process allows both tenants to be involved in the approval of access for the users or groups for remote access sessions.

Illustratively, the techniques described herein may be performed by hardware, software, and/or firmware, (e.g., an “apparatus”) such as in accordance with the secure equipment access process, process 248, (e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
determining, by an access broker, a first group of users of a first tenant within a computer network;
exposing, by the access broker, the first group of users to a second tenant within the computer network;
receiving, by the access broker, a selection of particular users from the first group of users for which the second tenant has granted remote access to one or more networked assets of the second tenant; and
managing, by the access broker, access of the particular users of the first tenant to the one or more networked assets of second tenant based on a group configuration for the first group of users by the first tenant and the selection of the particular users by the second tenant.

2. The method of claim 1, wherein the first group of users are identified as individual users.

3. The method of claim 1, wherein:
the first group of users is identified by a group name; and
individual users within the first group of users are obfuscated.

4. The method of claim 1, wherein the selection of the particular users is selected from a group consisting of: an entirety of the first group of users; one or more subgroups of the first group of users; and a subset of individual users from the first group of users.

5. The method of claim 1, further comprising:
receiving secure equipment access permissions for the particular users based on managing access of the particular users of the first tenant to the one or more networked assets of second tenant.

6. The method of claim 1, further comprising:
receiving access revocation of one or more of the particular users by the second tenant; and
revoking access of one or more of the particular users from the one or more networked assets of second tenant in response to the access revocation.

7. The method of claim 6, wherein access revocation of one or more of the particular users comprises removing an individual user from one or more of the particular users or removing a subset of users from one or more of the particular users.

8. The method of claim 1, further comprising:
receiving an update to the first group of users from the first tenant; and
updating the access according to the update.

9. The method of claim 8, wherein the update comprises adding users and, if all users of the second tenant are selected, adding access to new users in the second tenant.

10. The method of claim 8, wherein the update comprises adding users, and if individual users of second tenant group are selected, exposing new users but only allowing access if the second tenant grants access to added users.

11. The method of claim 8, wherein the update comprises removing users and auto-removing access of the users from second tenant.

12. An apparatus, comprising:
one or more network interfaces to communicate with a network;
a processor coupled to the one or more network interfaces and configured to execute one or more processes; and
a memory configured to store a process that is executable by the processor, the process comprising:
determining, by an access broker, a first group of users of a first tenant within a computer network;
exposing, by the access broker, the first group of users to a second tenant within the computer network;
receiving, by the access broker, a selection of particular users from the first group of users for which the second tenant has granted remote access to one or more networked assets of the second tenant; and
managing, by the access broker, access of the particular users of the first tenant to the one or more networked assets of second tenant based on a group configuration for the first group of users by the first tenant and the selection of the particular users by the second tenant.

13. The apparatus of claim 12, wherein the first group of users are identified as individual users.

14. The apparatus of claim 12, wherein:
the first group of users is identified by a group name; and
individual users within the first group of users are obfuscated.

15. The apparatus of claim 12, the process further comprising:
receiving secure equipment access permissions for the particular users based on managing access of the particular users of the first tenant to the one or more networked assets of second tenant.

16. The apparatus of claim 12, the process further comprising:
receiving access revocation of one or more of the particular users by the second tenant; and
revoking access of one or more of the particular users from the one or more networked assets of second tenant in response to the access revocation.

17. The apparatus of claim 16, wherein access revocation of one or more of the particular users comprises removing an individual user from one or more of the particular users or removing a subset of users from one or more of the particular users.

18. The apparatus of claim 12, the process further comprising:
receiving an update to the first group of users from the first tenant; and
updating the access according to the update.

19. The apparatus of claim 18, wherein the update comprises removing users and auto-removing access of the users from second tenant.

20. A tangible, non-transitory, computer-readable medium storing program instructions that cause a device to execute a process comprising:
determining, as an access broker, a first group of users of a first tenant within a computer network;
exposing the first group of users to a second tenant within the computer network;
receiving a selection of particular users from the first group of users for which the second tenant has granted remote access to one or more networked assets of the second tenant; and
managing, as the access broker, access of the particular users of the first tenant to the one or more networked assets of second tenant based on a group configuration for the first group of users by the first tenant and the selection of the particular users by the second tenant.
